(19) United States
(12) Patent Application Publication
(10) Pub. No.: US 2016/0131944 A1
(43) Pub. Date: May 12, 2016

(54) DISPLAY DEVICE AND MANUFACTURING METHOD THEREOF

(71) Applicant: Japan Display Inc., Tokyo (JP)

(72) Inventors: Takahiko ENDO, Tokyo (JP); Azusa Oyama, Tokyo (JP)

(21) Appl. No.: 14/932,207

(22) Filed: Nov. 4, 2015

(30) Foreign Application Priority Data
Nov. 6, 2014 (JP) 2014-226291

(51) Int. Cl. G02F 1/1335; G02F 1/1333; G02F 1/1345; G02F 1/1341; G02F 1/1368

(52) U.S. Cl. CPC G02F 1/133528; G02F 1/1341; G02F 1/1368; G02F 1/133514; G02F 1/13454; G02F 1/133351; G02F 2001/13415

(57) ABSTRACT

In a manufacturing method in which the bonding of polarizing plates is conducted after the cutting of bonded motherboards (motherboards bonded together) into a plurality of liquid crystal display panels, if the narrowing of frames progresses, a polarizing plate's edge can fail in fitting in the frame area and enter the display area. A manufacturing method of a display device includes: (a) bonding a first motherboard and a second motherboard together; (b) bonding a first polarizing plate to the first motherboard; (c) bonding a second polarizing plate to the second motherboard; and (d) dicing the first polarizing plate, the first motherboard, the second motherboard and the second polarizing plate all together.

### CLAIM OF PRIORITY

The present application claims priority from Japanese patent application JP2014-226291 filed on Nov. 6, 2014, the content of which is hereby incorporated by reference into this application.

### BACKGROUND

The present disclosure relates to a display device and is applicable to a display device having a polarizing plate, for example.

In order to increase the manufacturing yield of liquid crystal display panels, the manufacture of the liquid crystal display panels generally includes a process of forming a plurality of array substrates (each having thin-film transistors thereon) on a large-area motherboard while forming a plurality of counter substrates (each having color filters and other elements thereon) on another motherboard. Thereafter, a plurality of liquid crystal display panels are formed at the same time by dropping an appropriate amount of liquid crystal material into the inside of sealing members and thereafter bonding the two motherboards together. Cut lines extending along boundaries between adjoining liquid crystal display panels are formed on the bonded motherboards (scribing) and thereafter the bonded motherboards are cut into a plurality of liquid crystal display panels (breaking) by use of propagation of cracks along the cut lines (see JP-2007-183550A or the corresponding U.S. Pat. No. 7,583,351, for example). In the following description, the process of scribing and breaking will be referred to simply as “scribing”.

### SUMMARY

In a manufacturing method in which the bonding of polarizing plates is conducted after the cutting of the bonded motherboards into a plurality of liquid crystal display panels, if the narrowing of frames (i.e., the decrease in the width of the peripheral area situated outside the display area and having wiring and other elements formed therein) progresses, a deviation (error) in the bonding of the polarizing plates can cause a polarizing plate's edge to fail in fitting in the frame area and enter the display area.

The other objects and new features will become apparent from the description of the present disclosure and the accompanying drawings.

The outline of a representative method employed in the present disclosure can be described briefly as follows:

A manufacturing method of a display device includes: (a) bonding a first motherboard and a second motherboard together; (b) bonding a first polarizing plate to the first motherboard; (c) bonding a second polarizing plate to the second motherboard; and (d) dicing the first polarizing plate, the first motherboard, the second motherboard and the second polarizing plate all together.

### BRIEF DESCRIPTION OF THE DRAWINGS

FIG. 1 is a flow chart for explaining a manufacturing method of a display device according to an embodiment of the present invention.

FIG. 2 is a plan view for explaining a display device according to an example of the present invention.

FIG. 3 is a cross-sectional view taken along the line A-A′ in FIG. 2.

FIG. 4 is a schematic diagram for explaining an array substrate of the display device according to the example.

FIG. 5 is a schematic circuit diagram showing an example of circuitry of one pixel in the display device shown in FIG. 4.

FIG. 6 is a flow chart for explaining a manufacturing method of the display device according to the example.

FIG. 7 is a flow chart for explaining a cutting method for the display device according to the example.

FIG. 8A is a schematic diagram (a plan view and side views) for explaining the cutting method for the display device according to the example.

FIG. 8B is a schematic diagram (a plan view and a side view) for explaining the cutting method for the display device according to the example.

FIG. 8C is a plan view for explaining the cutting method for the display device according to the example.

FIG. 8D is a plan view for explaining the cutting method for the display device according to the example.

FIG. 8E is a plan view for explaining the cutting method for the display device according to the example.

FIG. 8F is a plan view for explaining the cutting method for the display device according to the example.

FIG. 8G is a side view for explaining the cutting method for the display device according to the example.

FIG. 8H is a side view for explaining the cutting method for the display device according to the example.

FIG. 9A is a schematic diagram for explaining a cut surface of a polarizing plate in a case where only the polarizing plate is cut by using a super cutter.

FIG. 9B is a schematic diagram for explaining the cut surface of the polarizing plate in the case where only the polarizing plate is cut by using the super cutter.

FIG. 10A is a schematic diagram for explaining a cut surface of a polarizing plate in a case where the polarizing plate and a motherboard are cut all together by means of dicing.

FIG. 10B is a schematic diagram for explaining the cut surface of the polarizing plate in the case where the polarizing plate and the motherboard are cut all together by means of the dicing.

FIG. 11 is a flow chart for explaining a cutting method for a display device according to a modification.

FIG. 12A is a schematic diagram (a plan view and side views) for explaining the cutting method for the display device according to the modification.

FIG. 12B is a plan view for explaining the cutting method for the display device according to the modification.

FIG. 12C is a plan view for explaining the cutting method for the display device according to the modification.

FIG. 12D is a schematic diagram (a plan view and a side view) for explaining the cutting method for the display device according to the modification.

FIG. 12E is a plan view for explaining the cutting method for the display device according to the modification.

FIG. 12F is a plan view for explaining the cutting method for the display device according to the modification.

FIG. 12G is a side view for explaining the cutting method for the display device according to the modification.

FIG. 12H is a side view for explaining the cutting method for the display device according to the modification.

### DESCRIPTION OF THE PREFERRED EMBODIMENTS

Referring now to the drawings, a description will be given in detail of a preferred embodiment (examples, comparative example and modifications). Incidentally, the present disclosure is given just as an instance for illustration, and modifications that can easily be conceived of by those skilled in the art without departing from the content of the present invention should naturally be contained in the scope of the present invention. While the drawings can indicate the width, thickness, shape, etc. of each part rather schematically compared to the actual mode of implementation for the sake of clarifying the explanation, the drawings are just examples for illustration and should not limit the interpretation of the present invention. In the description and drawings, elements equivalent to those already explained with reference to an aforementioned drawing are assigned the already-used reference characters and detailed explanation thereof can be omitted properly.

### Embodiment

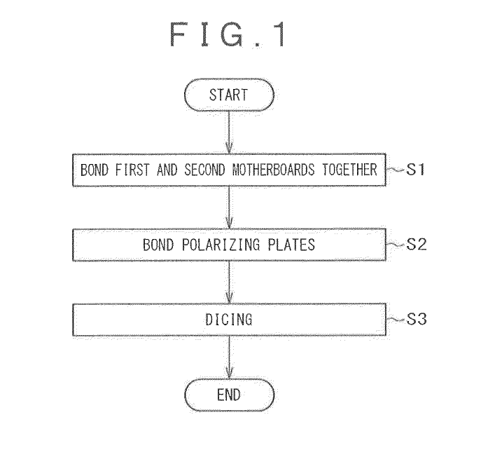

A manufacturing method of a display device according to an embodiment of the present invention will be described below with reference to FIG. 1.

FIG. 1 is a flow chart for explaining the manufacturing method of the display device according to this embodiment.

In the manufacturing method according to this embodiment, a first motherboard having a plurality of array substrates formed thereon and a second motherboard having a plurality of counter substrates formed thereon are bonded together (step S1) and polarizing plates are bonded to the first and second motherboards (step S2). The substrate made by bonding the first and second motherboards together will hereinafter be referred to as a “motherboard”. Thereafter, the motherboard is cut into a plurality of display panels by means of dicing (step S3). In cases where a polarizing plate is bonded to multiple array substrates (counter substrates) in a straddle manner, the dicing is carried out when the array substrates (counter substrates) are cut apart at their boundaries. The dicing is conducted at least when the array substrates (counter substrates) are cut apart at their long sides. The “dicing” is a cutting method in which an object is cut into two parts (situated on the left and right sides of a blade) by rotating the blade while pouring cutting water over the object of the cutting.

During the dicing, frictional heat is generated between the motherboard and the blade and between the polarizing plates and the blade. The parts of the polarizing plates in the vicinity of the cut surfaces (“diced” surfaces) are once melted by the heat and thereafter cooled down and solidified, forming a structure impeding moisture penetration (permeation) through the cut surfaces of the polarizing plates. Polarizing plates generally have the hygroscopicity (moisture absorbency). Thus, if a polarizing plate is kept in the atmosphere at the room temperature, the moisture content in the polarizing plate increases by approximately 20% compared to the initial state. In contrast, in the polarizing plate with the cut surfaces once melted and thereafter solidified, the increase in the moisture content is reduced to approximately 12% under the same conditions. Since the cut surfaces of the polarizing plate become fine and compact due to the solidification after melting, the moisture absorption through the cut surfaces can be suppressed.

Incidentally, the values of the moisture content shown here may vary depending on conditions such as the dicing condition and the storage condition after the cutting. However, the principle of suppressing the moisture absorption by the fine and compact cut surfaces of the polarizing plate formed by the solidification after melting is invariant.

Further, in each polarizing plate as a laminated structure (multilayer structure) made up of multiple thin films, the cut surfaces of the thin films are melted and integrated together. This suppresses the peeling off of part of the main body of the polarizing plate in the process of peeling a protective film (included in the polarizing plate) from the polarizing plate, for example. Furthermore, there are cases where edges (cut surfaces) of the protective film as the top surface of the polarizing plate turn white due to the heat. The whitened edges serve as marks in a subsequent process of peeling the protective film from the polarizing plate, which can lead to improvement in the working efficiency.

Since the polarizing plates and the motherboard are cut all together, the edge position of the array substrate and the edge position of the polarizing plate bonded to the array substrate can be made to substantially coincide with each other (the edge position of the counter substrate and the edge position of the polarizing plate bonded to the counter substrate can be made to substantially coincide with each other).

### EXAMPLE

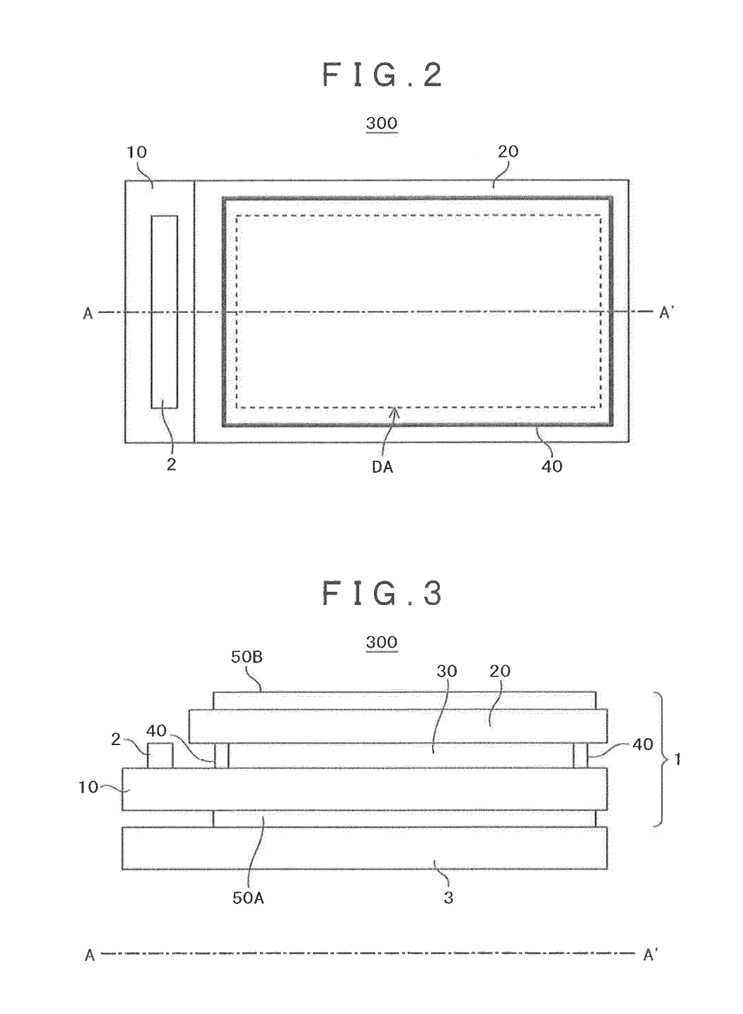

The configuration of a display device according to an example of the present invention will be described below with reference to FIGS. 2 to 5.

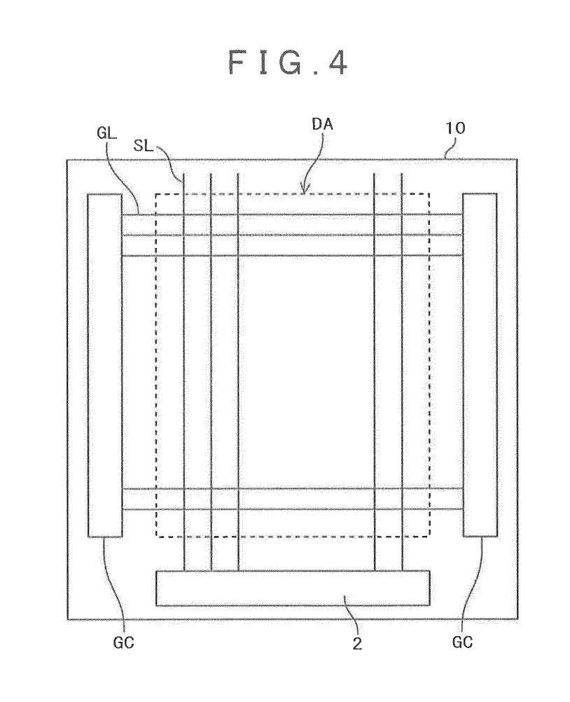

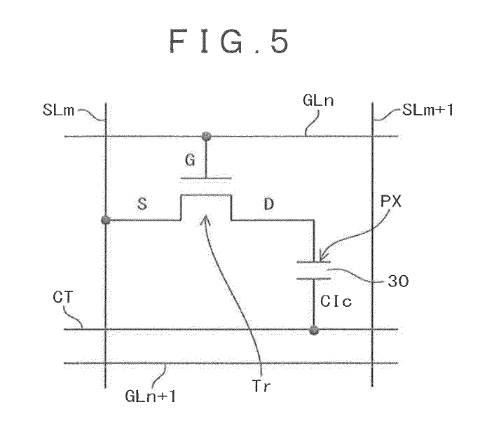

FIG. 2 is a plan view for explaining the display device according to this example. FIG. 3 is a cross-sectional view taken along the line A-A′ in FIG. 2. FIG. 4 is a schematic diagram for explaining an array substrate of the display device according to the example. FIG. 5 is a schematic circuit diagram showing an example of circuitry of one pixel in the display device shown in FIG. 4.

As shown in FIGS. 2 and 3, the display device of this example comprises a display panel 1, a driver IC 2 and a backlight 3. The display panel 1 includes an array substrate 10, a counter substrate 20, and a liquid crystal material 30 which is encapsulated between the array substrate 10 and the counter substrate 20. The array substrate 10 and the counter substrate 20 are bonded together by use of an annular sealing member 40 that surrounds a display area DA. The liquid crystal material 30 is hermetically encapsulated in the space surrounded by the array substrate 10, the counter substrate 20 and the sealing member 40. The surfaces of the array substrate 10 and the counter substrate 20 facing outward (i.e., surfaces opposite to the surfaces facing the liquid crystal material 30) are provided with polarizing plates 50A and 50B, respectively. The display area DA is formed of a set of pixels arranged in a matrix pattern, for example.

The array substrate 10 includes the driver IC 2, a gate scan circuit GC, a plurality of scan signal lines GL, and a plurality of video signal lines SL. The driver IC 2, which is implemented by a CMOS circuit on one silicon substrate, is mounted on the array substrate 10 by means of COG (Chip On Glass) mounting. The gate scan circuit GC is formed by thin-film transistors (TFTs) on a glass substrate constituting the array substrate 10. The scan signal lines GL are signal lines through which scan signals are inputted from the gate scan circuit GC. The video signal lines SL are signal lines through which video signals are inputted from the driver IC 2. The scan signal lines GL and the video signal lines SL are formed to be separate from each other via an insulation layer. Each video signal line SL intersects with a plurality of scan signal lines GL (when viewed in the direction orthogonal to the substrate) via the insulation layer. Incidentally, while the gate scan circuit GC is arranged on each side of the scan signal lines GL in FIG. 4, it is also possible to configure the left and right gate scan circuits GC to alternately drive the scan signal lines GL from one side.

Although not shown in FIG. 4, a TFT device (TFT element) is arranged in each pixel constituting the display area DA. As shown in FIG. 5, for example, when one TFT device is arranged in each pixel (at the ratio of 1:1), the gate electrode G of the TFT device Tr arranged for the region (pixel) surrounded by two adjacent scan signal lines GLn and GLn+1 (n: integer greater than 1) and two adjacent video signal lines SLm and SLm+1 (m: integer greater than 1) is connected to the scan signal line GLn, and the source electrode S of the TFT device Tr is connected to the video signal line SLm. The drain electrode D of the TFT device Tr is connected to a pixel electrode PX. Pixel capacitance CIc (which can also be referred to as “liquid crystal capacitance”) is formed by the pixel electrode PX, a common electrode CT (which can also be referred to as a “counter electrode”) and a liquid crystal layer 30. In regard to the source and drain electrodes of the TFT device Tr, the electrode connected to the video signal line SL is called the “source electrode” and the electrode connected to the pixel electrode PX is called the “drain electrode” in this embodiment. However, there can also be cases where the source and drain electrodes are named reversely, calling the electrode connected to the video signal line SL the “drain electrode” and the electrode connected to the pixel electrode PX the “source electrode”.

A glass substrate constituting the counter substrate 20 is provided with a light blocking layer, color filters (coloring layer), spacers, and so forth.

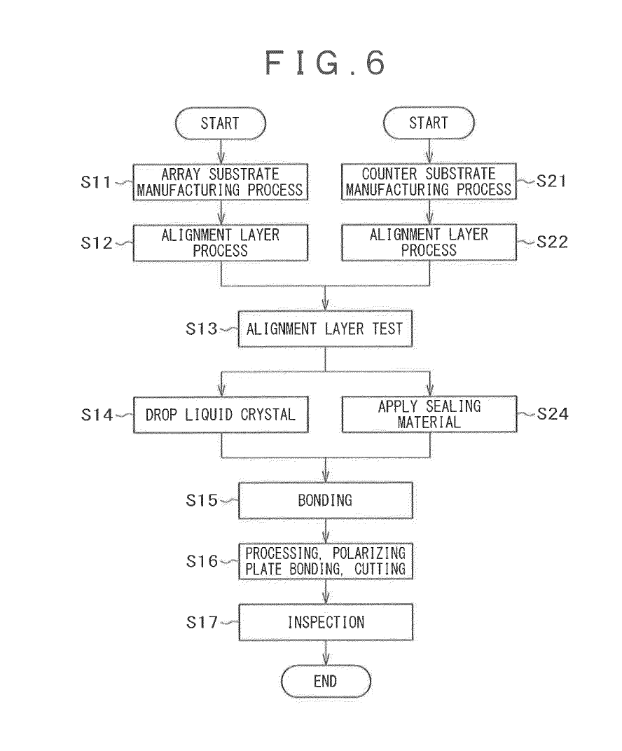

A manufacturing method of the display device according to the example will be described below with reference to FIG. 6.

FIG. 6 is a flow chart for explaining the manufacturing method of the display device according to this example.

The manufacturing process of the display device can be divided into three processes: an array substrate manufacturing process in which components such as pixel elements are formed on a first glass substrate constituting the first motherboard; a counter substrate manufacturing process in which components such as the color filters are formed on a second glass substrate constituting the second motherboard; and a cell formation process in which the first and second motherboards are bonded together.

First, by the array substrate manufacturing process, the scan signal lines and the video signal lines (arranged on the first motherboard and defining pixel regions) are formed, and a thin-film transistor connected to a scan signal line and a video signal line is formed in each of the pixel regions (step S11). By the array substrate manufacturing process, the pixel electrodes and the common electrodes, connected to the thin-film transistors for driving the liquid crystal layer by use of signals supplied via the thin-film transistors, are also formed. In cases where a liquid crystal display device of the vertical electric field type is manufactured, the common electrodes are formed on the second motherboard on which the color filters have been formed by the counter substrate manufacturing process.

Meanwhile, by the counter substrate manufacturing process, the light blocking layer and a color filter layer including red, green and blue color filters are formed on the second motherboard (step S21). By the counter substrate manufacturing process, the spacers for maintaining the cell gap at a constant distance are also formed. It is also possible to form the spacers on the first motherboard.

Subsequently, each of the first and second motherboard is coated with an alignment layer and thereafter an alignment process is performed on the alignment layers in order to supply alignment control force to the liquid crystal molecules in the liquid crystal layer formed between the first and second motherboards (steps S12 and S22). The alignment process can be carried out by use of the rubbing method or the optical alignment method. Subsequently, an alignment layer test for checking the presence/absence of an alignment layer defect is performed by an alignment layer tester on the first and second motherboards after undergoing the alignment layer processes (step S13).

A prescribed sealing pattern is formed on the second motherboard with a sealing material and the liquid crystal layer is formed by dropping the liquid crystal onto the first motherboard (steps S14 and S24). It is also possible to form a prescribed sealing pattern on the first motherboard with a sealing material and form the liquid crystal layer by dropping the liquid crystal onto the second motherboard. In this liquid dropping method, the liquid crystal is dropped and distributed onto an image display area of a large-area first motherboard (on which a plurality of array substrates have been arranged) or a large-area second motherboard (on which a plurality of counter substrates have been arranged) by use of a dispenser and then the liquid crystal layer is formed by uniformly distributing the liquid crystal to the entire image display area by use of the pressure used for bonding the first and second motherboards together. Therefore, when the liquid crystal layer is formed in the display panel by the liquid dropping method, the sealing pattern is formed in a closed shape surrounding the contour of the image display area to make it possible to prevent the leakage of the liquid crystal to the outside of the image display area.

The first motherboard with the liquid crystal dropped thereon and the second motherboard with the sealing material applied thereon are aligned (registered) with each other and then pressure is applied to the motherboards so that the first and second motherboards are bonded together with the sealing material and the dropped liquid crystal spreads uniformly across the entire panel (step S15). By such a process, a plurality of display panels, each having the liquid crystal layer formed therein, are formed in the large-area motherboard (first and second motherboards bonded together).

Thereafter, the motherboard is processed (e.g., abrasion of the glass substrates) as needed, the polarizing plates are bonded to the motherboard, and the motherboard is cut and separated into a plurality of display panels (step S16). The manufacture of the display panels is completed by inspecting each display panel (step S17). Further, display modules (display devices) are manufactured by attaching the driver IC, cables, backlight, etc. to each display panel.

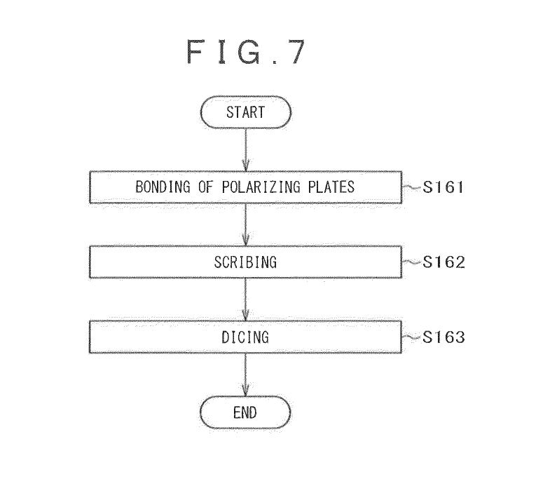

The details of the cutting method (step S16) for the display device according to the example will be explained below with reference to FIGS. 7 to 9.

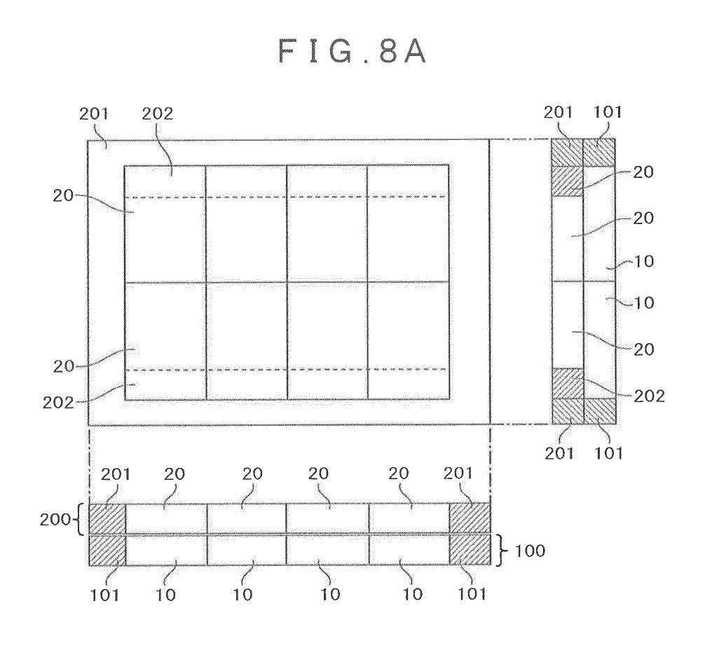

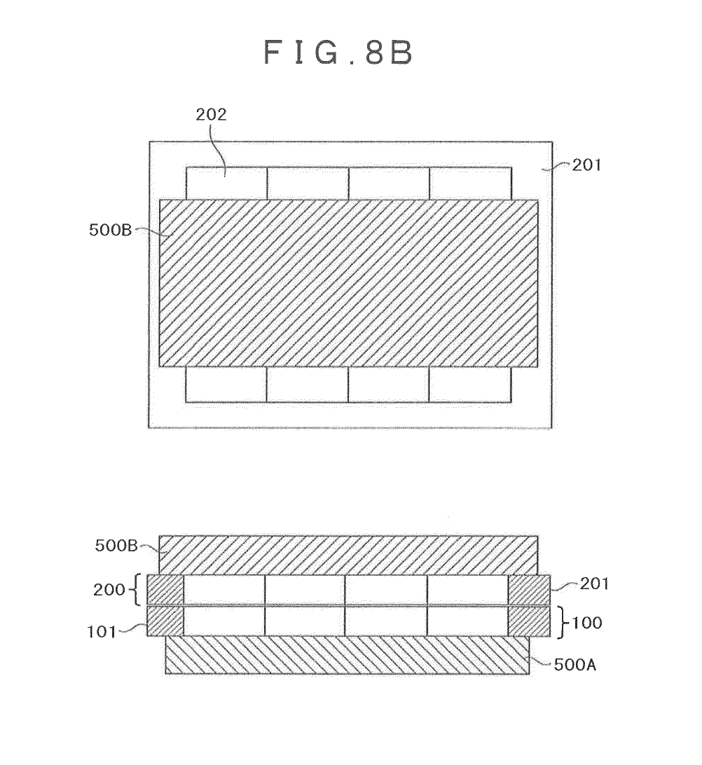

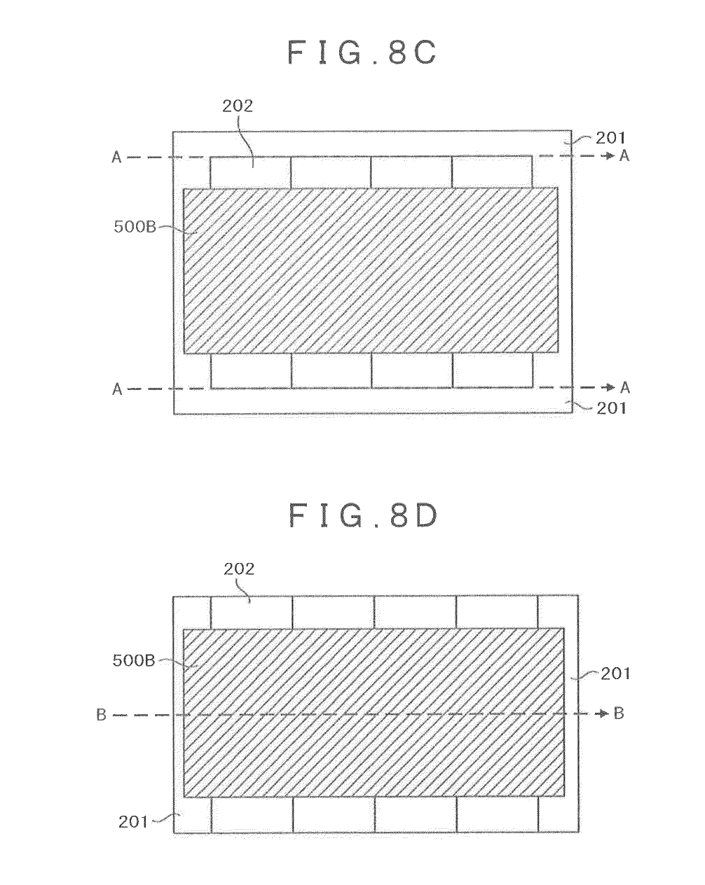

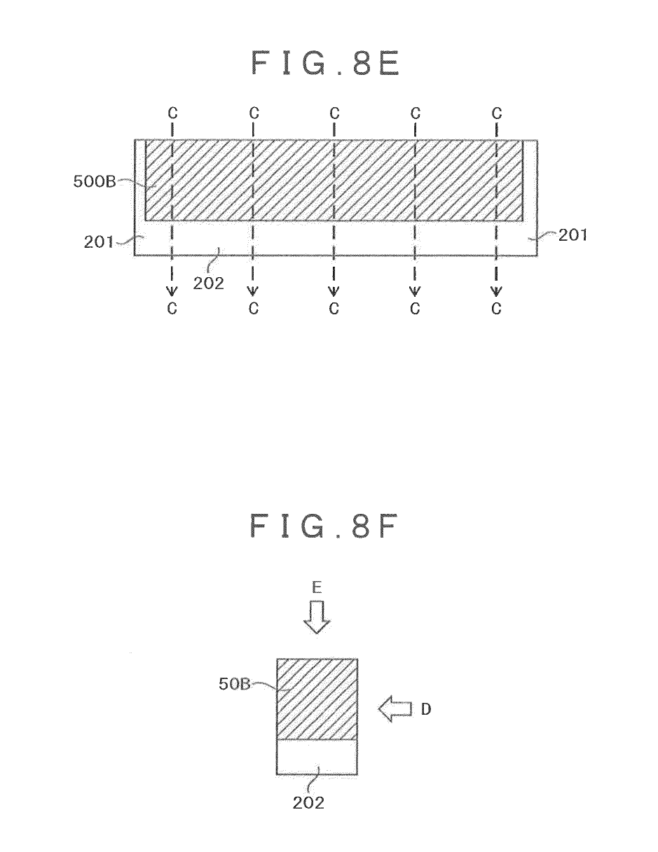

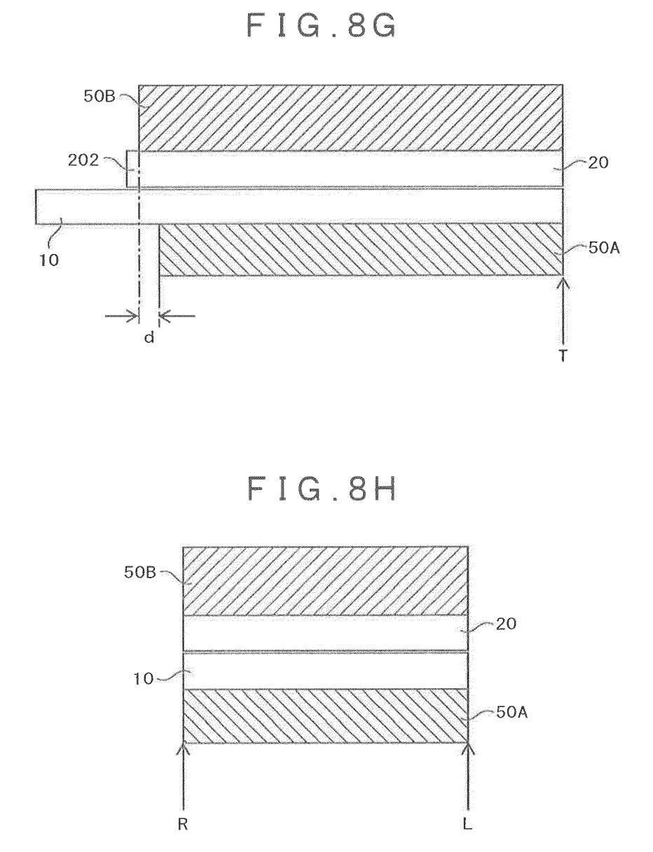

FIG. 7 is a flow chart for explaining the cutting method for the display device according to the example. FIG. 8A is a schematic diagram (a plan view and side views) for explaining the cutting method for the display device according to the example, wherein the upper left part is a plan view while the upper right part and the lower part are side views. FIG. 8B is a schematic diagram (a plan view and a side view) for explaining the cutting method for the display device according to the example, wherein the upper part is a plan view while the lower part is a side view. FIGS. 8C to 8F are plan views for explaining the cutting method for the display device according to the example. FIG. 8G is a side view in the direction D in FIG. 8F. FIG. 8H is a side view in the direction E in FIG. 8F.

As shown in FIG. 8A, a motherboard, which is obtained by thinning the bonded first and second motherboards 100 and 200 by means of abrasion (e.g., etching), is prepared. After the abrasion, an ITO (Indium Tin Oxide) film or a metal film with a low-reflection film may be formed on the second motherboard 200. The first motherboard 100 has a plurality of array substrates 10 and dummy regions 101. The second motherboard 200 has a plurality of counter substrates 20 and dummy regions 201 and 202. The dummy region 202 is a region where the counter substrate 20 is removed in order to mount the driver IC on the array substrate 10.

Subsequently, as shown in FIG. 8B, polarizing plates 500A and 500B are bounded to the first and second motherboards 100 and 200, respectively (step S161). Each polarizing plate 500A, 500B is formed by stacking up thin films such as a polarizing film, a substrate film, a release film and a protective film. Incidentally, the polarizing plates 500A and 500B are cut by using a super cutter when they are trimmed into prescribed sizes for the bonding to the first and second motherboards 100 and 200.

Subsequently, as shown in FIG. 8C, in order to cut away the dummy regions 101 and 201 situated in the upper and lower parts in FIG. 8C (the dummy regions 101 are behind the dummy regions 201 and thus invisible in FIG. 8C), the cutting of the motherboard is conducted by “scribing” along the broken lines A-A (step S162). The parts along the broken lines A-A are cut by means of the scribing since the parts have no polarizing plates 500A and 500B bonded thereto.

Subsequently, as shown in FIG. 8D, in order to separate adjoining counter substrates 20 (array substrates 10) from each other at their short sides, the cutting of the motherboard is conducted by dicing that along the broken line B-B (step S163). The part along the broken line B-B is cut by means of the dicing since the part has the polarizing plates 500A and 500B bonded thereto. The dicing is carried out while having the motherboard vacuum-sucked by a stage (e.g., perforated rubber), for example. Subsequently, as shown in FIG. 8E, in order to cut away the dummy regions 201 (dummy regions 101) situated in the left and right parts in FIG. 8E and to separate adjoining counter substrates 20 (array substrates 10) from each other at their long sides, the cutting of the motherboard is conducted by dicing that along the broken lines C-C (step S163). The parts along the broken lines C-C are cut by means of the dicing since the parts have the polarizing plates 500A and 500B bonded thereto. The arrow at the end of the broken line B-B and the arrows at the ends of the broken lines C-C indicate the directions of the progress of the dicing.

The bonding of the polarizing plates in the step S161 and the scribing in the step S162 may also be conducted in reverse order. Further, the scribing in the step S162 and the dicing in the step S163 may also be conducted in reverse order. However, the bonding of the polarizing plates in the step S161 and the dicing in the step S163 have to be conducted in this order. While the dicing is conducted from top to bottom in FIG. 8E, the dicing may be conducted in the reverse direction, or the cutting direction may be changed line by line.

As shown in FIG. 8F, each array substrate 10 (counter substrate 20) is formed into a rectangular shape by the dicing along the two long sides and the upper short side and the scribing along the lower short side. The dummy region 202 is removed by means of the scribing.

As shown in FIGS. 8G and 8H, at the diced parts (i.e., parts that have been undergone the cutting by means of the “dicing”) T, R and L, the position of the edge of the array substrate 10 coincides with the position of the edge of the polarizing plate 50A within an error range of ±50 μm to ±100 μm, and the position of the edge of the counter substrate 20 coincides with the position of the edge of the polarizing plate 50B within an error range of ±50 μm to ±100 μm. Incidentally, the diced part T is a short-side part of the array substrate 10 and the counter substrate 20, while the diced parts R and L are long-side parts of the array substrate 10 and the counter substrate 20. At the diced parts, the position of the edge of the polarizing plate 50A and the position of the edge of the polarizing plate 50B also coincide with each other within an error range of ±100 μm. However, at parts that have not undergone the dicing, the deviation d between the edge position of the polarizing plate 50A and the edge position of the polarizing plate 50B is greater than those at the diced parts as shown in FIG. 8G. In general, various deviations occur in the manufacturing process, such as a deviation occurring in the bonding of the first and second motherboards 100 and 200, a deviation in the scribe line position between the front side and the back side of the motherboard (the first and second motherboards 100 and 200 bonded together) occurring when the scribe lines are formed on the front and back sides of the motherboard, a deviation occurring in the bonding of the polarizing plate 500A to the first motherboard 100, and a deviation occurring in the bonding of the polarizing plate 500B to the second motherboard 200. Therefore, the magnitude of the deviation calculated statistically is necessitated to be, in principal, greater than the deviation occurring in each process.

If the dicing of the motherboard is conducted after bonding the polarizing plates to both sides (front and back sides) of the motherboard, the edge position of the array substrate and the counter substrate and the edge position of the polarizing plates on the front and back sides of the motherboard basically coincide with each other at the diced parts. However, the polarizing plates are made of material softer than glass (principal component of the array substrate and the counter substrate), and consequently, a deviation can occur in some degree between the edge position of the two polarizing plates and the edge position of the two substrates. That said, the difference (deviation) is within ±50 μm or ±100 μm even in such cases. In cases where the polarizing plates are bonded to the motherboard after the cutting of the motherboard, the deviation between the edge position of the array substrate and the counter substrate and the edge position of the polarizing plates does not fit within ±100 μm in many cases in the present technology. In other words, it is difficult in the present technology to bond the polarizing plates to the motherboard (the array substrate and the counter substrate) so that 3σ fits within 100 μm. Incidentally, no problem arises even if the deviation d is greater than 100 μm since a frame region along the short side of the array substrate 10 (counter substrate 20) has a greater margin in comparison with a frame region along the long side of the array substrate 10 (counter substrate 20).

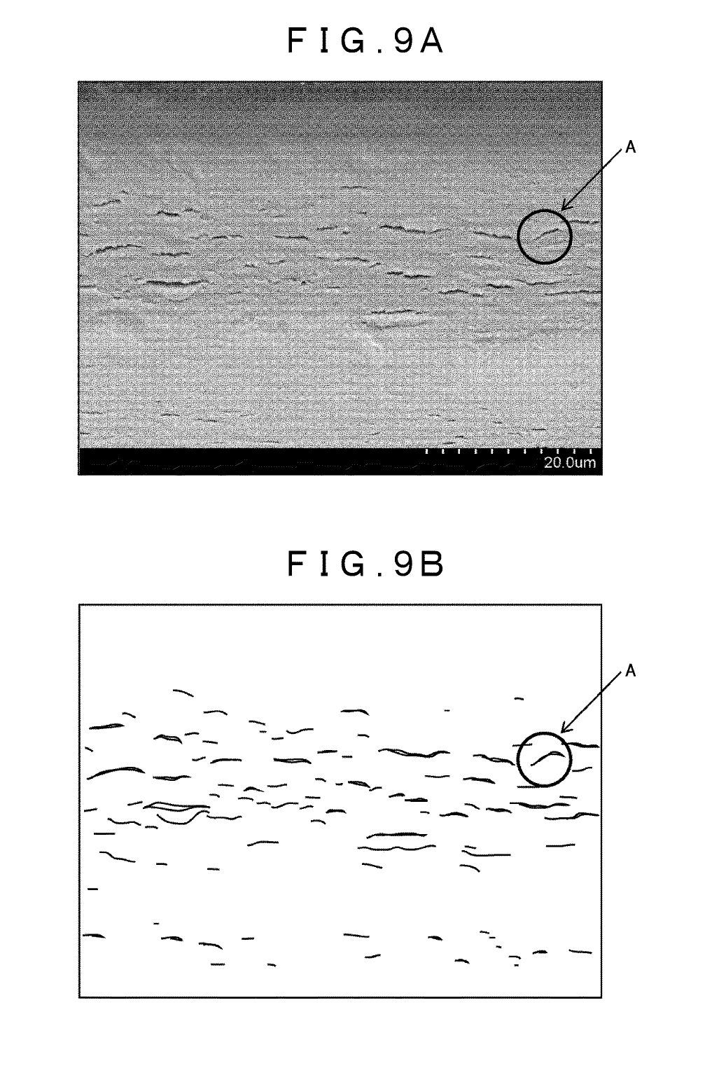

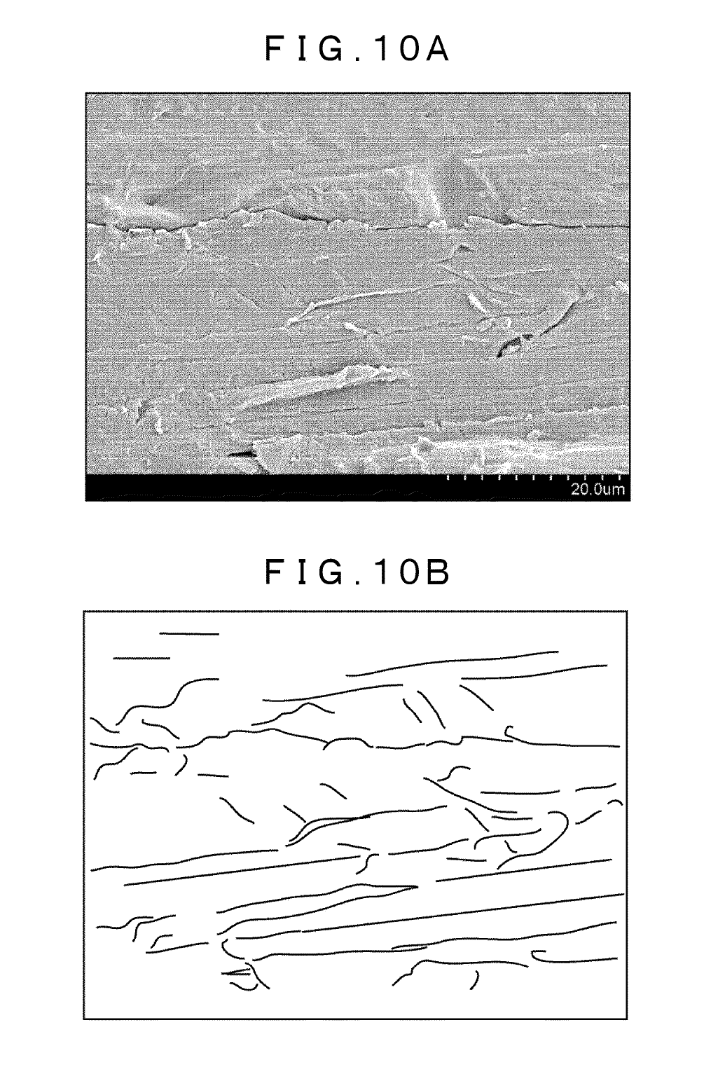

The status of the polarizing plates of the display device according to the example will be explained below with reference to FIGS. 9A to 10B.

FIGS. 9A and 9B are schematic diagrams for explaining a cut surface of a polarizing plate in a case where only the polarizing plate is cut by using the super cutter. FIG. 9A is a cross-sectional SEM image. FIG. 9B is a schematic diagram of FIG. 9A. FIGS. 10A and 10B are schematic diagrams for explaining a cut surface of a polarizing plate in a case where the polarizing plate and the motherboard are cut all together by means of the dicing. FIG. 10A is a cross-sectional SEM image. FIG. 10B is a schematic diagram of FIG. 10A.

As shown in FIGS. 9A and 9B, the polarizing plate after being cut with the super cutter has a lot of horizontally elongated voids extending in directions nearly in parallel with the lamination plane (see the inside of circle A, for example). Incidentally, the lower short side of the polarizing plate in FIG. 8F, which does not undergo the cutting by means of the dicing, remains in the state just after being cut with the super cutter before the bonding to the motherboard.

In contrast, as shown in FIGS. 10A and 10B, the polarizing plate after being cut by means of the dicing has oblique stripes left by the progress of the blade. Further, the horizontally elongated voids (which once existed as shown in FIGS. 9A and 9B) break and disappear since frictional heat is generated by the contact with the side face of the blade rotating at high speed and the cut surface of the polarizing plate is softened by the frictional heat and thereafter solidifies. Accordingly, the moisture penetration through the cut surfaces of the polarizing plates is suppressed. This leads to increased reliability of the polarizing plates as well as increased reliability of the display panel. In FIGS. 10A and 10B, the part that looks like a void is a shallow scar left by the dicing.

### <Modification>

While it has been explained (in the chapter of the cutting method for the display device according to the example) that the bonding of the polarizing plates in the step S161 and the scribing in the step S162 may also be conducted in reverse order, it is also possible to change part of the dicing into the scribing (modification). A cutting method for the display device according to the modification will be described below with reference to FIG. 8A and FIGS. 11 to 12H.

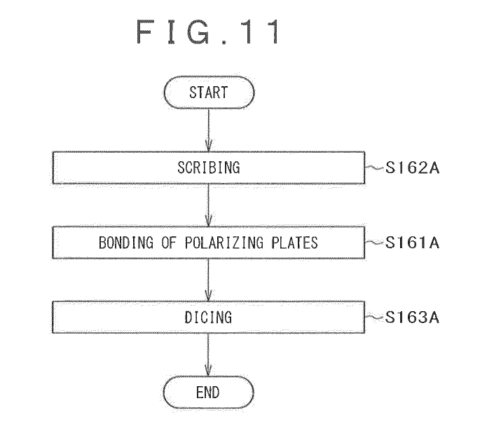

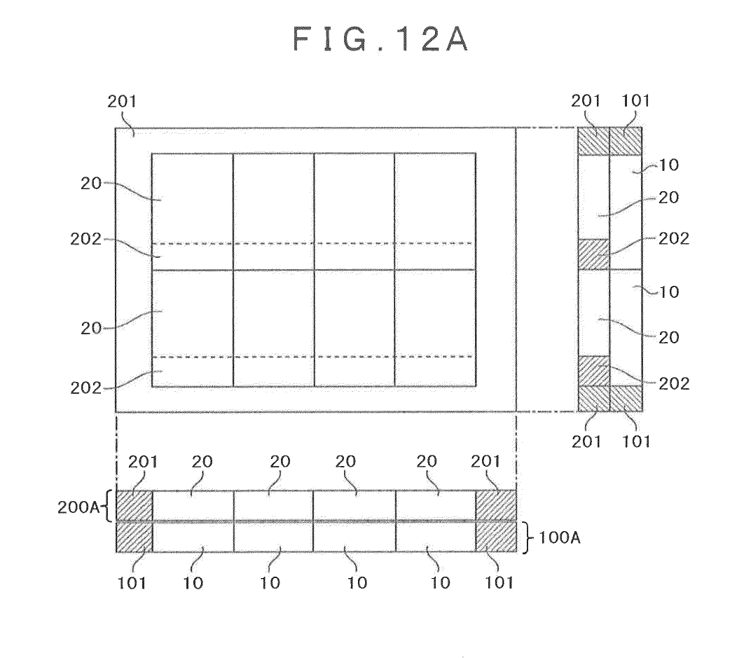

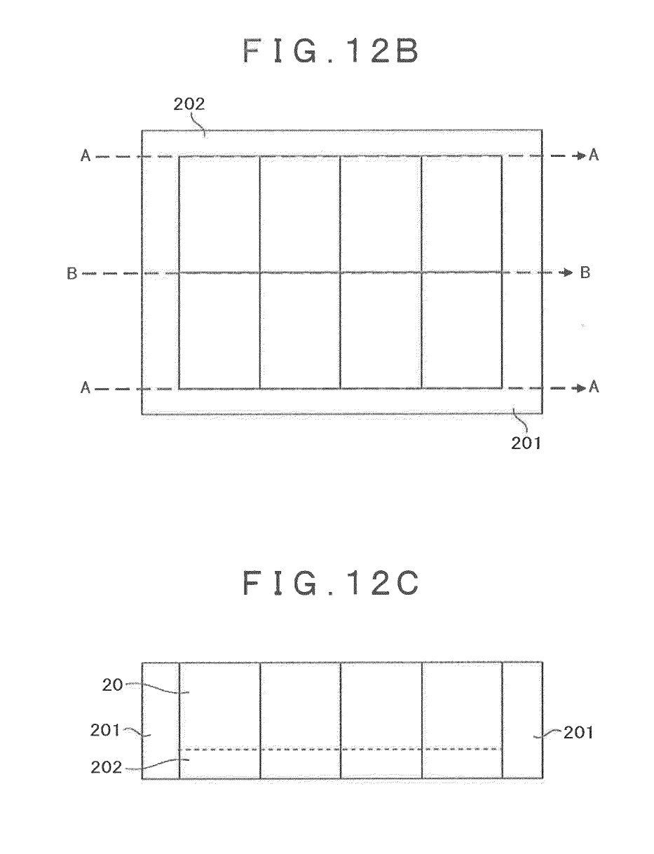

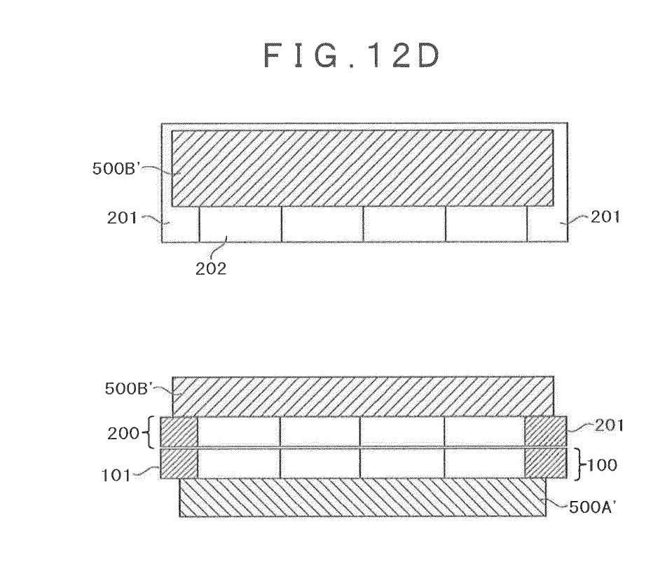

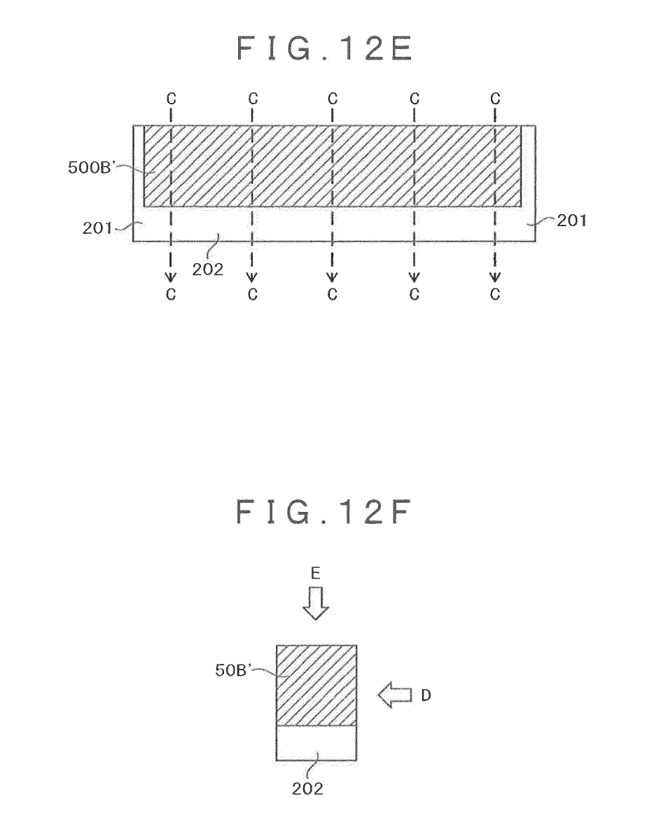

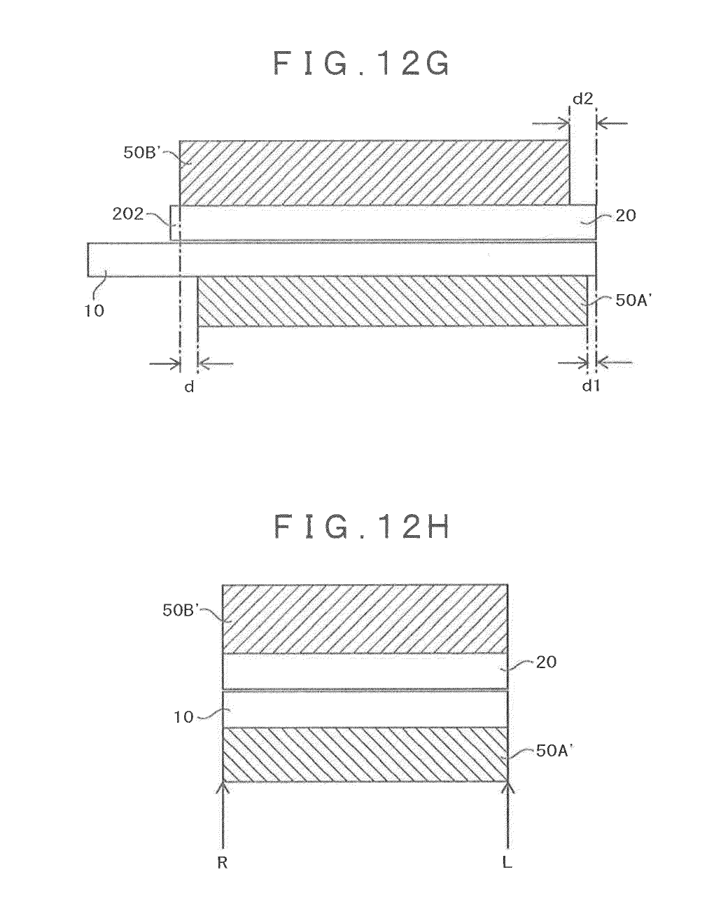

FIG. 11 is a flow chart for explaining the cutting method for the display device according to the modification. FIG. 12A is a schematic diagram (a plan view and side views) for explaining the cutting method for the display device according to the modification, wherein the upper left part is a plan view while the upper right part and the lower part are side views. FIG. 12D is a schematic diagram (a plan view and a side view) for explaining the cutting method for the display device according to the modification, wherein the upper part is a plan view, while the lower part is a side view. FIGS. 12B, 12C, 12E and 12F are plan views for explaining the cutting method for the display device according to the modification. FIG. 12G is a side view in the direction D in FIG. 12F. FIG. 12H is a side view in the direction E in FIG. 12F.

Similarly to the cutting method according to the above example, in the cutting method for the display device according to the modification, a motherboard like the one shown in FIG. 8A, obtained by thinning the bonded first and second motherboards 100 and 200 by means of abrasion (e.g., etching), is prepared. It is also possible to prepare a motherboard like the one shown in FIG. 12A by thinning bonded first and second motherboards 100A and 200A by means of abrasion (e.g., etching). After the abrasion, an ITO film or a metal film with a low-reflection film may be formed on the second motherboard 200/200A. The first motherboard 100/100A has a plurality of array substrates 10 and dummy regions 101. The second motherboard 200/200A has a plurality of counter substrates 20 and dummy regions 201 and 202. On the first motherboard 100 and the second motherboard 200, the array substrates 10 and the counter substrates 20 are respectively arranged in line symmetry with respect to the broken line B-B in FIG. 8D. In contrast, on the first motherboard 100A and the second motherboard 200A, the array substrates 10 and the counter substrates 20 are respectively arranged in the same direction.

Subsequently, as shown in FIG. 12B, in order to cut away the dummy regions 101 and 201 situated in the upper and lower parts of FIG. 12B, the cutting is conducted by “scribing” along the broken lines A-A. Further, in order to separate adjoining counter substrates 20 (array substrates 10) from each other at their short sides, the cutting is conducted by “scribing” along the broken line B-B (step S162A). By the cutting, a motherboard shown in FIG. 12C, in which adjoining counter substrates 20 (array substrates 10) are connected together at their long sides, is obtained. The parts along the broken lines A-A and the part along the broken line B-B are cut by means of the scribing since the parts have no polarizing plates 500A′ and 500B′ bonded thereto.

Subsequently, as shown in FIG. 12D, polarizing plates 500A′ and 500B′ are bonded to first and second motherboards 100B and 200B, respectively (step S161A). Here, the “first motherboard 100B” means the first motherboard 100 (100A) after undergoing the cutting by means of the scribing (in the state shown in FIG. 12C). Similarly, the “second motherboard 200B” means the second motherboard 200 (200A) after undergoing the cutting by means of the scribing. The polarizing plates 500A′ and 500B′ are basically the same as the polarizing plates 500A and 500B even though the sizes (planar shapes) of the polarizing plates 500A′ and 500B′ differ from those of the polarizing plates 500A and 500B. Incidentally, the polarizing plates 500A′ and 500B′ are cut by using the super cutter when they are trimmed into prescribed sizes for the bonding to the first and second motherboards 100B and 200B.

Subsequently, as shown in FIG. 12E, in order to cut away the dummy regions 201 (dummy regions 101) situated in the left and right parts in FIG. 12E and to separate adjoining counter substrates 20 (array substrates 10) from each other at their long sides, the cutting of the motherboard is conducted by dicing that along the broken lines C-C (step S163A). The parts along the broken lines C-C are cut by means of the dicing since the parts have the polarizing plates 500A′ and 500B′ bonded thereto. The arrows at the ends of the broken lines C-C indicate the direction of the progress of the dicing.

It is also possible to first conduct the scribing along the broken line B-B (step S162A), thereafter bond the polarizing plates (step S161A), and thereafter conduct the scribing along the broken lines A-A. Further, it is possible to previously carry out the bonding of polarizing plates (while avoiding the regions to be scribed) before conducting the scribing. While the dicing is conducted from top to bottom in FIG. 12E, the dicing may be conducted in the reverse direction, or the cutting direction may be changed line by line.

As shown in FIG. 12F, each array substrate 10 (counter substrate 20) is formed into a rectangular shape by the dicing along the two long sides and the scribing along the two short side. The dummy region 202 is removed by means of the scribing.

As shown in FIGS. 12G and 12H, at the diced parts R and L, the position of the edge of the array substrate 10 coincides with the position of the edge of the polarizing plate 50A′ within an error range of ±50 μm to ±100 μm, and the position of the edge of the counter substrate 20 coincides with the position of the edge of the polarizing plate 50B′ within an error range of ±50 μm to ±100 μm. Incidentally, the diced parts R and L are long-side parts of the array substrate 10 and the counter substrate 20. In contrast, at parts that have not undergone the dicing, the deviation d between the edge position of the polarizing plate 50A′ and the edge position of the polarizing plate 50B′ is great as shown in FIG. 12G. Further, the deviation d1 between the edge position of the array substrate 10 and the edge position of the polarizing plate 50A′ is greater than those at the diced parts R and L, and the deviation d2 between the edge position of the counter substrate 20 and the edge position of the polarizing plate 50B′ is greater than those at the diced parts R and L. If the dicing of the motherboard is conducted after bonding the polarizing plates to both sides (front and back sides) of the motherboard, the edge position of the array substrate and the counter substrate and the edge position of the polarizing plates on the front and back sides of the motherboard basically coincide with each other at the diced parts. However, the polarizing plates are made of material softer than glass (principal component of the array substrate and the counter substrate), and consequently, a deviation can occur in some degree between the edge position of the two polarizing plates and the edge position of the two substrates. That said, the difference (deviation) is within ±50 μm or ±100 μm even in such cases. In cases where the polarizing plates are bonded to the motherboard after the cutting of the motherboard, the deviation between the edge position of the array substrate and the counter substrate and the edge position of the polarizing plates does not fit within ±100 μm in many cases. Incidentally, no problem arises even if the deviations d, d1 and d2 are greater than 100 μm since the frame region along the short side of the array substrate 10 (counter substrate 20) has a greater margin in comparison with the frame region along the long side of the array substrate 10 (counter substrate 20).

In the cutting method for the display device according to the modification, the number of times of the dicing can be decreased compared to the cutting method for the display device according to the example. Since the throughput of the dicing is lower than that of the scribing, the total throughput can be improved through the decrease in the number of times of the dicing. Further, in the cutting method for the display device according to the modification, the size of the motherboard to be loaded into the dicing apparatus can be reduced in comparison with the cutting method for the display device according to the example. Accordingly, the use of a smaller dicing apparatus becomes possible.

Incidentally, while each of the array substrate and the counter substrate has been assumed to be a substrate made by forming elements (devices) and a resin layer on a glass substrate, the configuration of each substrate is not particularly limited. For example, it is also possible to use a substrate made of resin or the like instead of the glass substrate. Further, while the above description of the display panel has been given of a liquid crystal display panel, display panels using organic EL for the pixels (OLEDs) may also be employed. Also in such organic EL display panels using organic EL for the pixels, there are cases where color filters and polarizing plates are arranged on the counter substrate's side of the display panel. The present invention is applicable to such cases. Nevertheless, irrespective of which type of display panel is employed, the display panel is not limited to the configuration arranging the color filters on the counter substrate; the color filters may be arranged on the array substrate's side of the display panel or on neither of the substrates.

While the polarizing plate is generally formed by sandwiching a polarizer between protective films, the configuration of the polarizing plate is not limited to this example. For example, it is possible to employ a protective film that gives a phase difference, or to arrange one or more layers of phase difference plates (wave plates) in addition to the protective films. Further, while the polarizing plates have been illustrated as an example of components in the above description of the present invention, the present invention is applicable to a wide variety of components (such as a different type of optical sheet, cover glass or touch panel) bonded to the array substrate or the counter substrate. While the expression “polarizing plate” has been used in this description, such a polarizing plate may also be referred to as a “polarizing sheet” or a “polarizing film”.

What is claimed is:

1. A manufacturing method of a display device, comprising:
(a) bonding a first motherboard and a second motherboard together;
(b) bonding a first polarizing plate to the first motherboard;
(c) bonding a second polarizing plate to the second motherboard; and
(d) dicing the first polarizing plate, the first motherboard, the second motherboard and the second polarizing plate all together.

2. The manufacturing method of a display device according to claim 1, wherein in the step (d), the first polarizing plate, the first motherboard, the second motherboard and the second polarizing plate are cut by rotating a blade while pouring cutting water over the object of the cutting.

3. The manufacturing method of a display device according to claim 1, comprising scribing the first and second motherboards after the step (a) and before the step (d).

4. The manufacturing method of a display device according to claim 3, comprising scribing the first and second motherboards before the steps (b) and (c).

5. The manufacturing method of a display device according to claim 3, comprising scribing the first and second motherboards after the steps (b) and (c).

6. The manufacturing method of a display device according to claim 1, comprising abrading the first and second motherboards after the step (a) and before the steps (b) and (c).

7. The manufacturing method of a display device according to claim 1, comprising scribing the first and second motherboards after the step (d).

8. The manufacturing method of a display device according to claim 1, comprising dicing the first polarizing plate, the first motherboard, the second motherboard and the second polarizing plate all together after the step (d).

9. The manufacturing method of a display device according to claim 1, wherein:
each of the first and second polarizing plates includes a protective film, and
the manufacturing method comprises peeling the protective films off after the step (d).

10. The manufacturing method of a display device according to claim 1, wherein a liquid crystal is encapsulated between the first and second motherboards by a liquid dropping method in the step (a).

11. A display device comprising:
an array substrate in a rectangular shape in a plan view;
a counter substrate in a rectangular shape in a plan view;
a liquid crystal layer sandwiched between the array substrate and the counter substrate;
a first polarizing plate in a rectangular shape in a plan view which is arranged on the array substrate; and
a second polarizing plate in a rectangular shape in a plan view which is arranged on the counter substrate, wherein:
each of the first and second polarizing plates is formed of a laminated film,
the position of an edge of the array substrate at its first long side and the position of an edge of the first polarizing plate at its first long side coincide with each other in a plan view within an error range of ±100 μm and the position of an edge of the array substrate at its second long side and the position of an edge of the first polarizing plate at its second long side coincide with each other in a plan view within an error range of ±100 μm, and
the position of an edge of the counter substrate at its first long side and the position of an edge of the second polarizing plate at its first long side coincide with each other in a plan view within an error range of ±100 μm and the position of an edge of the counter substrate at its second long side and the position of an edge of the second polarizing plate at its second long side coincide with each other in a plan view within an error range of ±100 μm.

12. The display device according to claim 11, wherein:
the position of the edge of the array substrate at its first long side and the position of the edge of the first polarizing plate at its first long side coincide with each other in a plan view within an error range of ±50 μm and the position of the edge of the array substrate at its second long side and the position of the edge of the first polarizing plate at its second long side coincide with each other in a plan view within an error range of ±50 μm, and
the position of the edge of the counter substrate at its first long side and the position of the edge of the second polarizing plate at its first long side coincide with each other in a plan view within an error range of ±50 μm and the position of the edge of the counter substrate at its second long side and the position of the edge of the second polarizing plate at its second long side coincide with each other in a plan view within an error range of ±50 ∥m.

13. The display device according to claim 11, wherein:
the position of an edge of the array substrate at its first short side and the position of an edge of the first polarizing plate at its first short side coincide with each other in a plan view within an error range of ±100 μm, and
the position of an edge of the counter substrate at its first short side and the position of an edge of the second polarizing plate at its first short side coincide with each other in a plan view within an error range of ±100 μm.

14. The display device according to claim 13, wherein:
the position of the edge of the array substrate at its first short side and the position of the edge of the first polarizing plate at its first short side coincide with each other in a plan view within an error range of ±50 μm, and
the position of the edge of the counter substrate at its first short side and the position of the edge of the second polarizing plate at its first short side coincide with each other in a plan view within an error range of ±50 μm.

15. The display device according to claim 11, wherein:
cut surfaces of the first polarizing plate at its first and second long sides are in a state after undergoing melting, and
cut surfaces of the second polarizing plate at its first and second long sides are in a state after undergoing melting.

16. The display device according to claim 15, wherein
a cut surface of the first polarizing plate at its first short side is in a state after undergoing melting, and
a cut surface of the second polarizing plate at its first short side is in a state after undergoing melting.

17. The display device according to claim 11, further comprising a driver IC which is arranged on the array substrate at a position between a second short-side part of the array substrate and a second short-side part of the counter substrate.

18. The display device according to claim 11, wherein the array substrate includes thin-film transistors and pixel electrodes.

19. The display device according to claim 18, wherein the counter substrate includes a light blocking layer and color filters.

20. The display device according to claim 18, wherein the array substrate includes common electrodes.
